(19) United States
(12) Patent Application Publication
(10) Pub. No.: US 2015/0046461 A1
(43) Pub. Date: Feb. 12, 2015

(54) System and Method of Sharing Cultural Information

(71) Applicant: Didier M. Mahan, Indianapolis, IN (US)

(72) Inventor: Didier M. Mahan, Indianapolis, IN (US)

(21) Appl. No.: 14/455,717

(22) Filed: Aug. 8, 2014

Related U.S. Application Data
(60) Provisional application No. 61/863,633, filed on Aug. 8, 2013.

(51) Int. Cl. G06F 17/30; H04L 29/06; H04L 12/58; H04L 29/08; G06F 3/0481; G06F 3/0484

(52) U.S. Cl. CPC G06F 17/30867; G06F 3/0481; G06F 3/04842; H04L 51/32; H04L 67/06; H04L 51/14; H04L 51/04; G06F 17/30598; H04L 65/403
USPC 707/740

(57) ABSTRACT

A system and method for sharing cultural information through a user interface such as a website, wherein a user account and a plurality of other user accounts are registered on the website. The user account can link to the plurality of other user accounts such that a plurality of media content can be shared among the linked user accounts. The plurality of media content files includes images, videos, music, and text. Each of the plurality of media content files includes a category tag and a nationality tag. As a result, the user account can search for a desired media content file by searching for the category tag or the nationality tag. Additionally, the user account can also electronically message the plurality of other user accounts which is linked to the user account.

The current application claims a priority to the U.S. Provisional Patent application Ser. No. 61/863,633 filed on Aug. 8, 2013.

### FIELD OF THE INVENTION

The present invention relates generally to online social networking and social media. More specifically, the present invention is a cultural exchange system for increasing globalization and knowledge through the posting and sharing of media content relating to specific countries.

### BACKGROUND OF THE INVENTION

The “cultural divide” is a term used to describe the separation of peoples, communities, nations, etc. based on cultural differences. This can contribute to isolation between countries as well as hinder interactions and relations. While the cultural divide can be attributed to a variety of factors such as ideological differences, oftentimes it is simply a matter of knowledge and/or lack of exposure. This is particularly an issue in developing countries where technology may not be widespread or advanced. As a result, the people of developing countries may not be knowledgeable about the outside world as a whole. The cultural divide is a significant issue in a modern world that is becoming more globalized on a daily basis. Ignorance and lack of exposure can lead to stereotyping, misunderstandings, further alienation between people, and a widening of the cultural divide. Bridging the cultural divide between parties is possible by educating all parties about cultural differences of the other parties. Education can lead to a deeper understanding of other cultures and foster improved trust, cooperation, and communication between parties. Increased cooperative and harmonious interaction between parties can also aid in bridging the cultural divide as this allows parties to become familiar with one another. The present invention seeks to facilitate cultural exchange with the intent of increasing knowledge and globalization in order to bridge the cultural divide.

The present invention is a cultural exchange system through which a diverse and multicultural user base may post and share media relating to individual countries. In its preferred embodiment, the present invention comprises an online interactive platform such as a website. The website serves as a centralized hub for the world's countries, each of which is assigned a respective website that may be accessed by users through the centralized hub. Users are able to interact with one another through the individual country websites. Users who reside in or who originate from a specific country may post and share media content relating to the country. Various types of media content may be posted including, but not limited to, photographs, videos, music, and text. The media content may disclose multiple aspects of countries including, but not limited to:
Culture/tradition: music, cuisine, holidays, language, art, literature, recreation (sports, nightlife, etc.), multimedia (film, television programming, etc.)
Geography
Climate
Politics
Education: primary, secondary, tertiary
Tourism opportunities

The cultural exchange system places emphasis on sharing knowledge of day-to-day life and interactions of the peoples of various countries. This is particularly beneficial for familiarizing users with the lives and experiences of common people living in other countries.

The object of the present invention is to bridge the cultural divide by increasing knowledge of other countries, people, and cultures. Many countries in the modern world are melting pots in which large numbers of ethnic groups form a collective society. The present invention provides a platform through which users may share information about these ethnic groups as well as their contributions to larger collective societies. In addition to bridging the cultural gap by increasing knowledge of the world's societies, the present invention is able to provide real life benefits for users as well. For example, users who wish to study abroad may familiarize themselves with the societies, education systems, and education opportunities of various possible countries in which to study. Additionally, users who are traveling or moving to a country may utilize the cultural exchange system to familiarize themselves with the country.

### BRIEF DESCRIPTION OF THE DRAWINGS

FIG. 1 is a flowchart illustrating the basic overall method of the present invention.

FIG. 2 is a flowchart illustrating the process for the request of interaction of the present invention.

FIG. 3 is a flowchart illustrating the process of electronically messaging another user account through the present invention.

FIG. 4 is a flowchart illustrating the process of uploading an image file in the present invention.

FIG. 5 is a flowchart illustrating the process of uploading a video file in the present invention.

FIG. 6 is a flowchart illustrating the process of advocating a desired file, commenting on a desired file, and sharing a desired file in the present invention.

FIG. 7 is a flowchart illustrating the process of creating a poll in the present invention.

### DETAIL DESCRIPTIONS OF THE INVENTION

All illustrations of the drawings are for the purpose of describing selected versions of the present invention and are not intended to limit the scope of the present invention.

The present invention is a system and a method for sharing cultural information which allows a diverse and multicultural user base to post and share media content relating to individual countries. The system includes a website and a server. The website is the user interface of the system. The present invention bridges the cultural divide by increasing knowledge, awareness, and familiarity amongst people from different countries. More specifically, the present invention performs as a cultural exchange system that functions through an interactive platform.

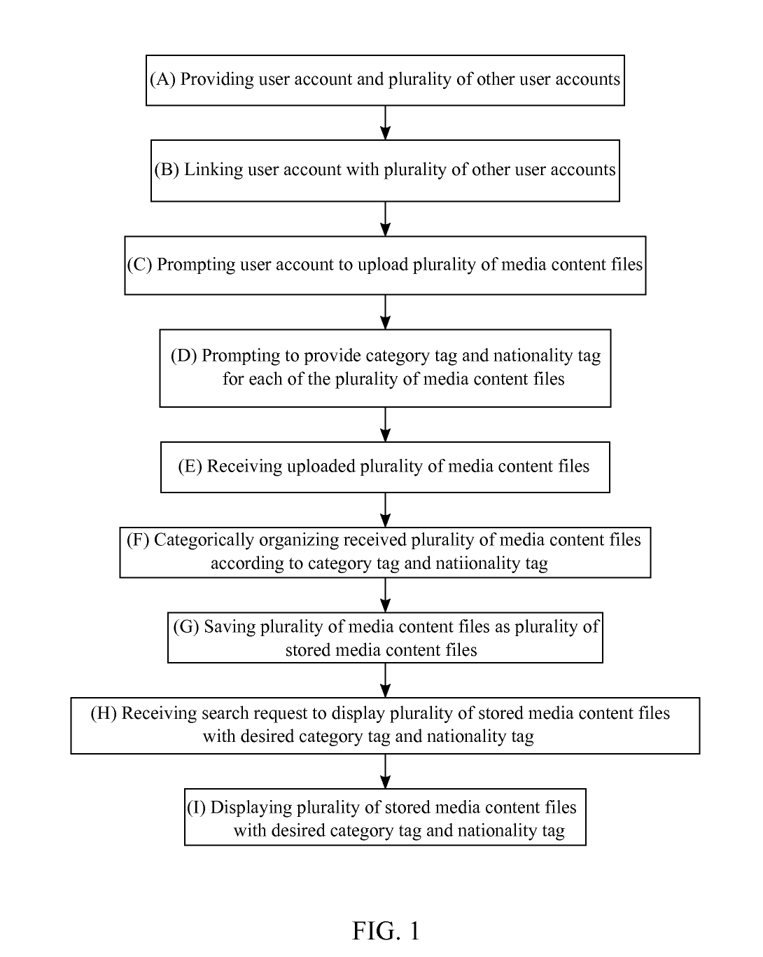

In the process of sharing information on the website, the user primarily creates a user account. Upon creating the user account, a plurality of media content can be shared on the website through the user account. The plurality of media content can be, but is not limited to, pictures, videos, music, and text. In order to view the plurality of media content shared through the user account, at least one other user account is linked to the user account. More specifically, the user account and the other user account are linked together through a plurality of social networking features of the present invention. The overall process of the present invention is illustrated in FIG. 1.

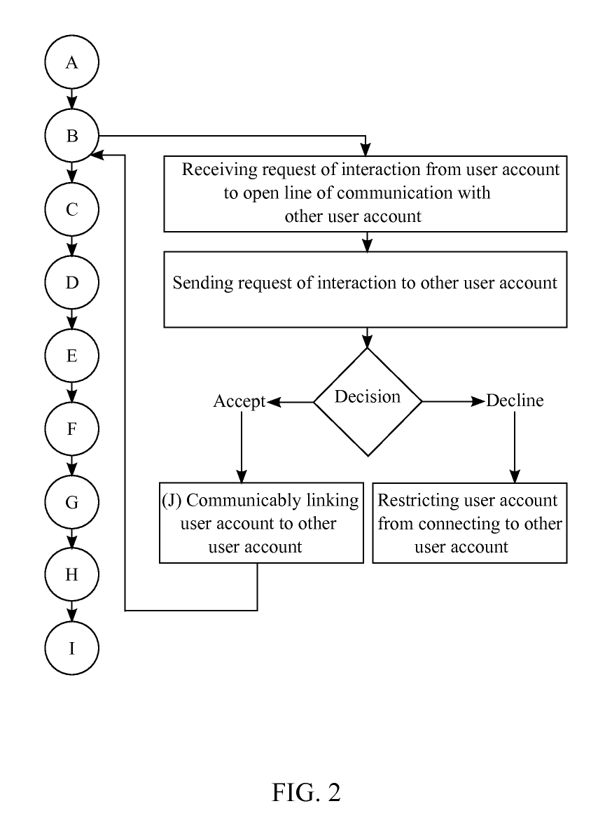

In order to connect the user account with the other user account, the present invention executes the following linking process. Initially, the server receives a request of interaction from the user account to open a line of communication with the other user account. Upon receiving the request of interaction, the server sends the request of interaction to the other user account as seen in FIG. 2. Next, the user account is communicably linked to the other user account if the other user account accepts the request of interaction. As a result, the user account opens the line of communication with the other user account as one of the plurality of social networking features of the present invention.

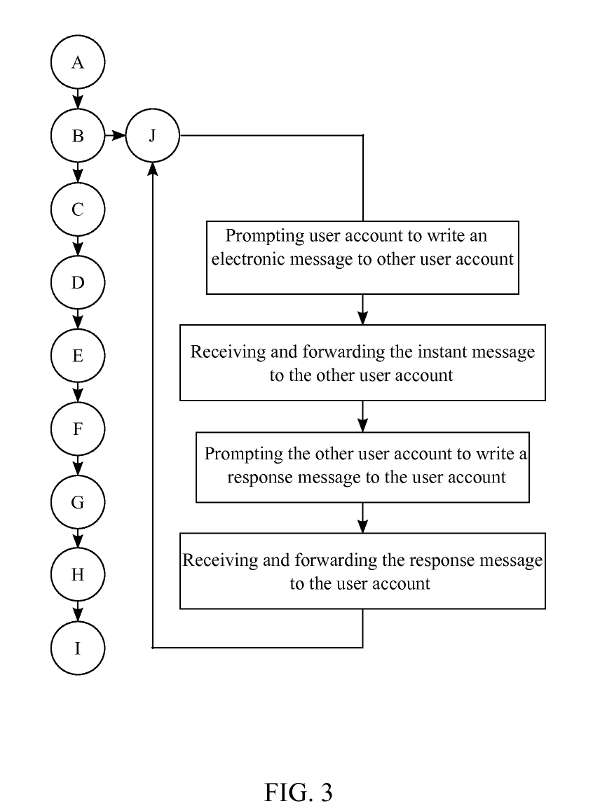

In addition to viewing content shared by the other user account, the user account can also electronically message the other user account as another one of the social networking features. The ability to electronically message the other user account is especially beneficial if the user account intends on obtaining more information regarding the content shared by the other user account. For instance, if a user from the United States views content posted by a user from France, the user from United States can further communicate with the user from France through the electronic messaging feature. The process flow of the electronic messaging feature is illustrated in FIG. 3. In order to electronically message the other use account, the present invention initially prompts the user account to write an instant message to the other user account. When writing the instant message is complete, the server receives the instant message from the user account and forwards the instant message to the other user account. Next, the other user account is prompted to write a response message to the user account. Upon receiving the response message from the other user account, the server forwards the response message to the user account such that the user account and the other user account can communicate with each other through electronic messaging. The same procedure can be followed multiple times according to preference of the user account and preference of the other user account.

As previously mentioned, pictures, video, and music can be shared on the website through the user account. Therefore, the server stores a plurality of stored media content files wherein each of the plurality of stored media content files is associated with a category tag and a nationality tag. The plurality of stored media content is beneficial in understanding the culture and lifestyle of another country. As an example, a user in the United States can view the plurality of stored media content shared by a user in the Ivory Coast and get a better understanding of the culture. In addition to providing new knowledge, the ability to view unique cultural information is extremely beneficial in closing the cultural gap. In order to share pictures, video, or music through the user account the present invention executes the following process. Initially, the server prompts the user account to upload at least one new media content file. Next, the server prompts the user account to select the category tag for the new media content. The category tag can be, but is not limited to, arts, music, fashion, food, sports, and tourism. As a result, the other user account linked with the user account, can search the new media content file by the category tag. After the category tag is received, the server prompts the user account to select the nationality tag for the new media content file. The nationality tag is utilized to search the new media content file by nationality. The nationality tag is beneficial when searching for information regarding different countries. When both the category tag and the nationality tag are submitted by the user account, the server organizes the new media content file into the stored media content files by the category tag and the nationality tag.

Similar to uploading new media content, the user account can also search for desired media content files shared by the other user account. In order to do so, the present invention receives a search request from the user account to view desired media content files, wherein each of the desired media content files of the search request is associated with a desired category tag. When the server receives the search request, the desired category tag is compared to the category tag of each of the stored media content files. As a result, the present invention has the ability to find the desired media content files within the plurality of stored media content files. When the present invention finds the plurality of media content files with the desired category tag, the desired media content files are displayed to the user account. Furthermore, the server also has the ability to receive a search narrowing request from the user account to view desired media content files with a desired nationality tag. When the search narrowing request is received, the server compares the desired nationality tag to the nationality tag of each of the plurality of stored media content files. Afterwards, the server displays the desired media content files with the desired nationality tag to the user account through the website.

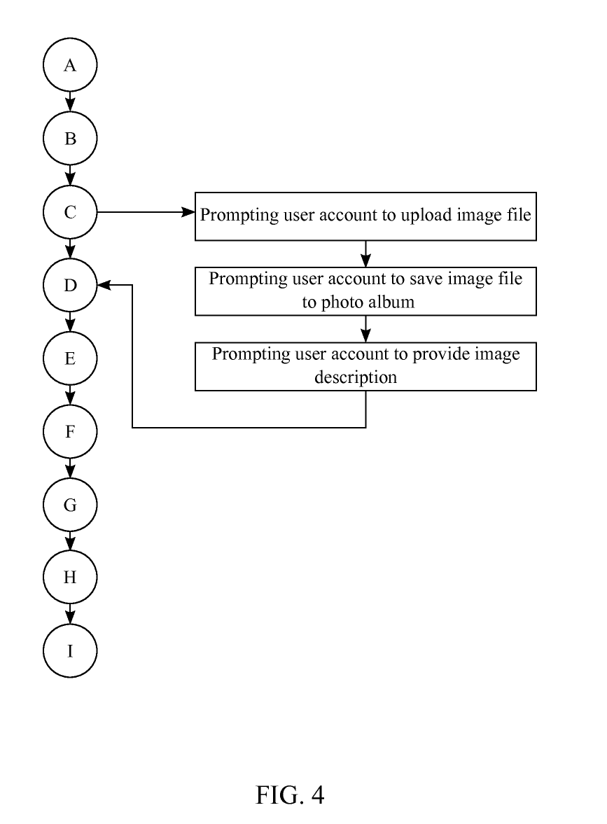

Image files makeup a portion of the plurality of the stored media content files. In the image uploading process, the server prompts the user account to upload an image file as one of the plurality of stored media content files. In uploading the image file the following process is followed. As illustrated in FIG. 4, the server first prompts the user account to upload the image file to a photo album, wherein the photo album is associated with the user account. Next, the server prompts the user account to select the category tag and also a nationality tag for the image file. In order to provide information to the other user account viewing the image file, the server prompts the user account to provide an image description. Afterwards, the server receives the image file and organizes the image file in the photo album of the user account. Finally, the server utilizes the category tag and the nationality tag to organize the image file into the plurality of stored media content files.

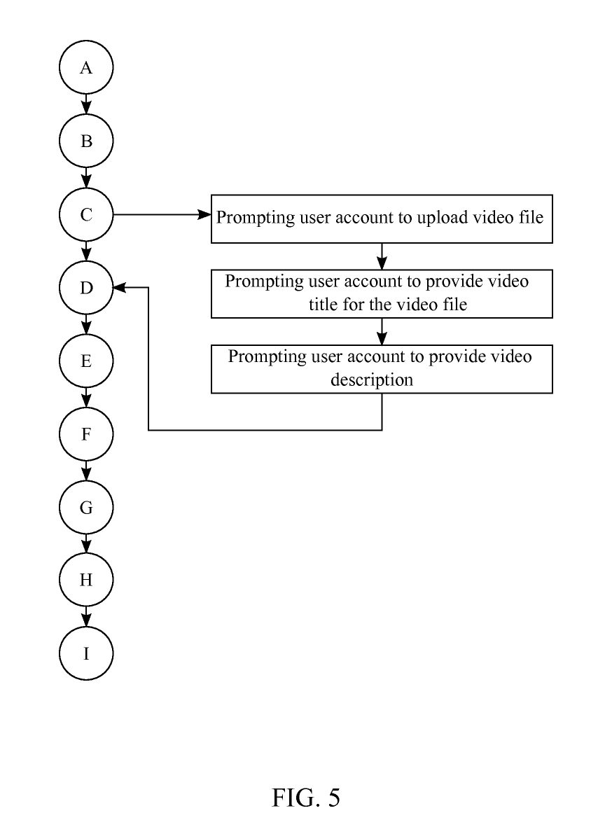

The present invention also allows the user account to upload a video file. As seen in FIG. 5, the server prompts the user account to upload the video file as one of the plurality of stored media content files. For future reference, the server also prompts the user account to provide a title for the video file. Next, the server prompts the user account to provide a video description for the video file which allows another user to get a better understanding of the video file when viewed through the website. Similar to the process of uploading an image file, the server prompts the user account to provide a category tag and a nationality tag when uploading the video file. Upon receiving the category tag and the nationality tag, the video file is organized into the plurality of stored media content files by the category tag and the nationality tag. As a result, the other user account is able to find the video file by the category tag and the nationality tag. Additionally, the video file can also be rotated and uploaded from a video source according to user preference.

In addition to images and videos, the server also has the ability to receive an audio file. In doing so, the server initially prompts the user to upload the audio file as one of the plurality of stored media content files. Once the audio file is received, the server organizes the audio file into the plurality of media content files.

When viewing the plurality of stored media content files, the user account may come across a plurality of preferred media content files. In order to express preference, the present invention allows the user account to advocate a desired file from the plurality of stored media content files as one of the plurality of social networking features. In doing so, the server initially prompts the user account to advocate the desired file. When the user account responds, the server receives an advocation tally for the desired file from the user account. Afterwards, when the desired file is displayed on the website, it is displayed along with the advocation tally.

When browsing through the plurality of stored media content, the user account may wish to comment on a desired file. In order to do so, the present invention allows the user account to comment on a desired file from the plurality of stored media content files. In the process of commenting on a desired file, the server first prompts the user to comment on a desired file. If the user account comments on the desired file, the server receives the comment text for the desired file from the user account. Upon receiving the comment text, the server displays the desired file with the comment text and additional comment texts from the plurality of other user accounts through the website.

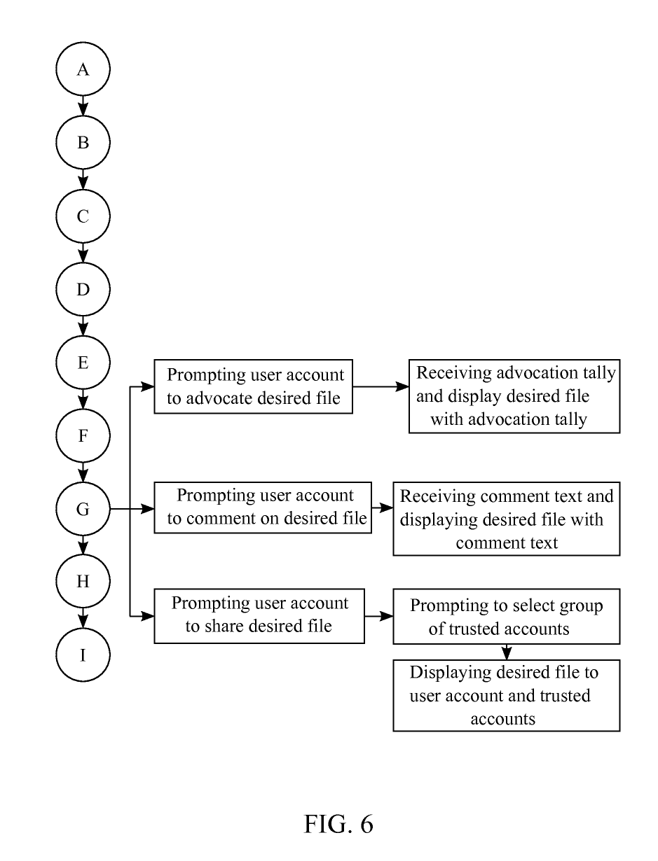

Similar to advocating a desired file and commenting on a desired file, the user account may also prefer to share a desired file. As one of the plurality of social networking features, the present invention is equipped with the ability to share the desired file from the plurality of stored media content files. As a result, the plurality of other user accounts linked with the user account will also have the ability to view the desired file. In the process of sharing the desired file, the server first prompts the user account to share the desired file. Next, the user account is prompted to select a group of trusted accounts from the plurality of other user accounts. When selecting the group of trusted accounts is complete, the desired file is displayed to the user account and the group of trusted accounts. The process of advocating the desired file, commenting on the desired file, and sharing the desired file is illustrated in FIG. 6.

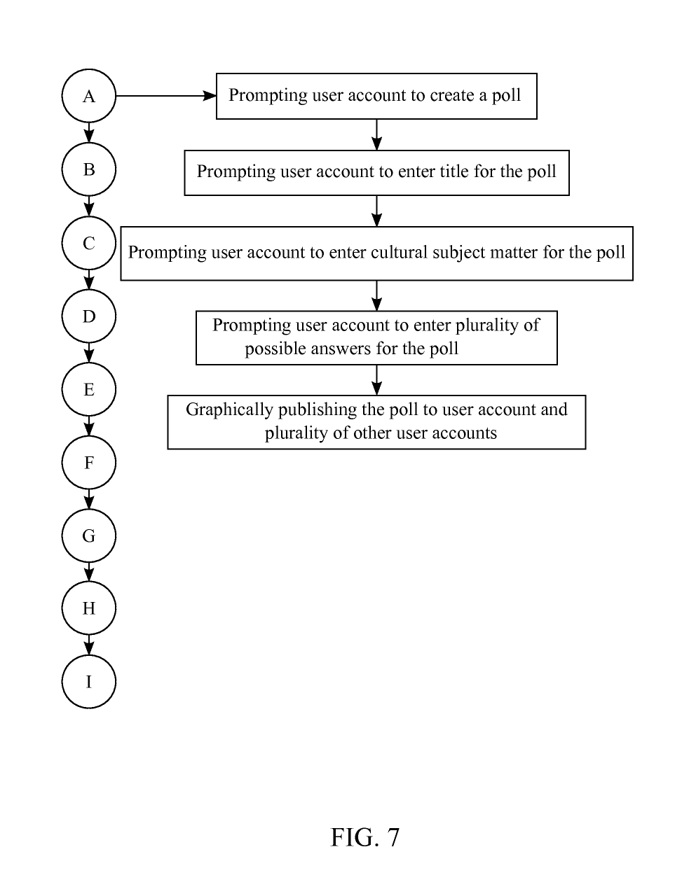

As mentioned earlier, the plurality of stored media content files are beneficial in sharing cultural knowledge. However, knowledge of different subject matters can also be exchanged through a question and answer system. As seen in FIG. 7, the present invention allows the user account to poll the plurality of other user accounts on a cultural subject matter as one of the plurality of social media networking features. In order to create a new poll, the server initially prompts the user account to create a poll with a title. Next the user account is prompted to enter cultural subject matter for the poll. The subject matter can be, but is not limited to, information regarding geographical information, traditions, and sports of a particular country. Next, the user account is prompted to create a plurality of possible answers for the poll. When viewing the poll, the plurality of other user accounts will select an answer from the plurality of possible answers provided by the user account. Upon completion, the server graphically publishes the poll through the website to the user account and the plurality of other user accounts that view the poll. When the plurality of other user accounts visits the website, the server prompts the plurality of other user accounts to interact with the poll. When the plurality of other user accounts answers the poll, the server records the answer selections from the user account and also the plurality of other user accounts. Finally, the answer selections are graphically displayed to the user account and also the plurality of other user accounts. As a result, the plurality of other user accounts gains valuable cultural information that might have been unknown previously.

In addition to bridging the cultural divide, the plurality of stored media content and the polls offered through the present invention serves as an extensive database of knowledge and opportunities. For example, the plurality of stored media content can be utilized to familiarize with a potential travel destination as well as develop an itinerary. Furthermore, a primary user of the present invention may interact with other users of the present invention, who are residing in or who are familiar with a potential travel destination to more thoroughly research the destination before travel. The resident users may also provide information about local events, opportunities, and activities that the primary user may be interested in during the course of his or her trip. A similar example involves the education systems of various countries. The primary user who wishes to study abroad may utilize the plurality of stored media content files to obtain information about societies, education systems, and education opportunities in potential study abroad countries. Additionally, the primary user may converse with local students in the potential study abroad countries to gain a better understanding of student life in those countries. This allows local students to provide information as well as answer any questions that the primary user may have.

Although the invention has been explained in relation to its preferred embodiment, it is to be understood that many other possible modifications and variations can be made without departing from the spirit and scope of the invention as hereinafter claimed.

What is claimed is:

1. A method for uploading, viewing, and sharing cultural content on an electronic communication device by executing computer-executable instructions stored on a non-transitory computer-readable medium, the method comprises the steps of:
providing a user account;
providing a plurality of stored media content files, wherein each of the plurality of stored media content files is associated with a category tag and a nationality tag;
linking the user account to a plurality of other user accounts through a plurality of social networking features;
prompting the user account to upload at least one new media content file;
prompting the user account to select the category tag for the new media content file;
prompting the user account to select the nationality tag for the new media content file;
receiving and organizing the new media content file into the plurality of stored media content files by the category tag and the nationality tag;
receiving a search request from the user account to view desired media content files, wherein the desired media content files is associated with a desired category tag;
comparing the desired category tag to the category tag of each of the plurality of stored media content files in order to find the desired media content files within the plurality of stored media content files;
displaying the desired media content files to the user account;
receiving a search narrowing request from the user account to view the desired media content files with a desired nationality tag;
comparing the desired nationality tag to the nationality tag of each of the plurality of stored media content files in order to find the desired media content files with the desired nationality tag; and
displaying the desired media content files with the desired nationality tag to the user account.

2. The method for uploading, viewing, and sharing cultural content on an electronic communication device by executing computer-executable instructions stored on a non-transitory computer-readable medium, the method as claimed in claim 1 further comprises the steps of:
wherein the user account opens a line of communication with at least one other user account as one of the plurality of social networking features;
receiving a request of interaction from the user account to open the line of communication with the other user account;
sending the request of interaction to the other user account; and
communicably linking the user account to the other user account, if the other user account accepts the request of interaction.

3. The method for uploading, viewing, and sharing cultural content on an electronic communication device by executing computer-executable instructions stored on a non-transitory computer-readable medium, the method as claimed in claim 2 further comprises the steps of:
wherein the user account is able to electronically message the other user account as another one of the plurality of social networking features;
prompting the user account to write an instant message to the other user account;
receiving and forwarding the instant message to the other user account;
prompting the other user account to write a response message to the user account; and
receiving and forwarding the response message to the user account.

4. The method for uploading, viewing, and sharing cultural content on an electronic communication device by executing computer-executable instructions stored on a non-transitory computer-readable medium, the method as claimed in claim 1 further comprises the steps of:
prompting the user account to upload an image file as one of the plurality of stored media content files;
prompting the user account to save the image file to a photo album, wherein the photo album is associated with the user account;
prompting the user account to select the category tag for the image file;
prompting the user account to enter a image description for the image file;
prompting the user account to select the nationality tag for the image file;
receiving and organizing the image file into the photo album; and
organizing the image file into the plurality of stored media content files by the category tag and the nationality tag.

5. The method for uploading, viewing, and sharing cultural content on an electronic communication device by executing computer-executable instructions stored on a non-transitory computer-readable medium, the method as claimed in claim 1 further comprises the steps of:
prompting the user account to upload a video file as one of the plurality of stored media content files;
prompting the user account to provide a title for the video file;
prompting the user account to provide a video description for the video file;
prompting the user account to provide the category tag and the nationality tag for the video file; and
receiving and organizing the video file into the plurality of the stored media content files by the category tag and the nationality tag.

6. The method for uploading, viewing, and sharing cultural content on an electronic communication device by executing computer-executable instructions stored on a non-transitory computer-readable medium, the method as claimed in claim 1 further comprises the steps of:
prompting the user account to upload an audio file as one of the plurality of stored media content files; and
receiving and organizing the audio file to a music playlist within the plurality of stored media content files.

7. The method for uploading, viewing, and sharing cultural content on an electronic communication device by executing computer-executable instructions stored on a non-transitory computer-readable medium, the method as claimed in claim 1 further comprises the steps of:
wherein the user account is able to advocate a desired file from the plurality of stored media content files as one of the plurality of social networking features;
prompting the user account to advocate the desired file;
receiving an advocation tally for the desired file from the user account; and
displaying the desired file with the advocation tally.

8. The method for uploading, viewing, and sharing cultural content on an electronic communication device by executing computer-executable instructions stored on a non-transitory computer-readable medium, the method as claimed in claim 1 further comprises the steps of:
wherein the user account is able to comment on a desired file from the plurality of stored media content files as one of the plurality of social networking features;
prompting the user account to comment on the desired file;
receiving a comment text for the desired file from the user account; and
displaying the desired file with the comment text and additional comment texts from the plurality of other user accounts.

9. The method for uploading, viewing, and sharing cultural content on an electronic communication device by executing computer-executable instructions stored on a non-transitory computer-readable medium, the method as claimed in claim 1 further comprises the steps of:
wherein the user account is able to share a desired file with the plurality of other user accounts as one of the plurality of social networking features;
wherein the desired file is from the plurality of stored media content files;
prompting the user account to share the desired file;
prompting the user account to select a group of trusted accounts from the plurality of other user accounts; and
displaying the desired file to the user account and the group of trusted accounts.

10. The method for uploading, viewing, and sharing cultural content on an electronic communication device by executing computer-executable instructions stored on a non-transitory computer-readable medium, the method as claimed in claim 1 further comprises the steps of:
wherein the user account is able to poll the plurality of other user accounts on a cultural subject matter as one of the plurality of social media networking features;
prompting the user account to create a poll;
prompting the user account to enter a title for the poll;
prompting the user account to enter the cultural subject matter for the poll;
prompting the user account to enter a plurality of possible answers for the poll;
graphically publishing the poll to the user account and the plurality of other user accounts;
prompting the user account and the plurality of other user accounts to interact with the poll;
recording answer selections for the poll from the user account and from the plurality of other user accounts; and
graphically displaying the answer selections to the user account and the plurality of user accounts.
